(19) United States
(12) Patent Application Publication
(10) Pub. No.: US 2024/0245004 A1
(43) Pub. Date: Jul. 25, 2024

(54) HARVESTING APPARATUS FOR TALL GROWING CROPS

(71) Applicant: Oil Palm Harvesting Company Ltd., Calgary (CA)

(72) Inventors: Curtis Christopher BLUNDELL, Calgary (CA); Jarret Richard SUN, Calgary (CA); Daniel POLLARD, Calgary (CA)

(73) Assignee: Oil Palm Harvesting Company Ltd., Calgary, AB (CA)

(21) Appl. No.: 18/420,274

(22) Filed: Jan. 23, 2024

Related U.S. Application Data
(60) Provisional application No. 63/441,039, filed on Jan. 25, 2023.

(51) Int. Cl. A01D 46/20; A01D 46/253; A01D 67/00; A01D 69/02; A01D 69/03

(52) U.S. Cl. CPC A01D 46/20; A01D 46/253; A01D 67/00; A01D 69/02; A01D 69/03

(57) ABSTRACT

An apparatus and method are provided for harvesting tall growing crops, such as fresh fruit bunches from oil palm trees. The apparatus includes an integrated mechanism for propulsion with automated leveling outriggers, a ramp type FFB storage dump tray, a semi-automated telescoping aerial lift tower with an automated telescoping structural stabilizer mechanism, a semi-automated 3-link rotatably articulating extendable manipulator arm mechanism with an operator carrying platform or basket, a mechanized FFB capturing screw device and a mechanized FFB cutting device

### CROSS-REFERENCE TO RELATED APPLICATIONS

This application claims priority of U.S. Provisional Patent Application Ser. No. 63/441039, filed Jan. 25, 2023, which is incorporated by reference into this application in its entirety.

### TECHNICAL FIELD

The present disclosure is related to harvesting equipment for tall crops in general and, in particular, to a single operator controlled mechanized, self-propelled and semi-automated harvesting apparatus that captures and cuts oil palm Fresh Fruit Bunches (“FFB”) from oil palm trees at heights from 8-12 meters and loads and transports the harvested FFBs from the oil palm trees to a central location within an oil palm plantation.

### BACKGROUND

All oil palm is grown in plantations within a 20° latitude range about the earth's equator. FFB's are harvested manually from oil palm trees up to 15 meters in height.

For young oil palm trees that are between 1 and 3.5 meters in height, the manual harvesting of FFBs involves a handheld blade style chisel with an extension of up to 2 meters in length that is physically manipulated from the ground to cut the stalk of the FFB allowing the FFB to fall to the ground. Impact with the ground causes oil palm fruitlets to separate from the FFB and disperse.

For mature oil palm trees that are between 3.5 and 15 meters in height, the manual harvesting of FFBs involves a handheld scythe blade connected to an adjustable pole up to 13 meters in length. The blade is manually positioned and vigorously manipulated to cut the stalk of the FFB allowing the FFB to fall to the ground. Falling from high elevations further separates fruitlets from the FFB and causes bruising damage that affects the quality and value of harvest.

FFBs are gathered from the ground either manually or with a mechanical grapple and loaded into wheel barrels or powered wagons for transport to collection areas within the plantation. The loose oil palm fruitlets dispersed on the ground are gathered separately and loaded manually into wheel barrels or powered wagons for transport to collection areas within the plantation.

It is accepted within the industry that manual harvesting of oil palm FFBs is slow, physically demanding work. Due to shortages in skilled harvesting labor and inefficient operations, hundreds of millions and, more recently, billions of dollars of healthy FFB production is left unharvested and rotting in the trees every year.

It is accepted within the industry that a significant quantity of FFBs are not harvested due to the difficulty in cutting the stem of the FFB while manipulating the cutting tool from the ground due to the height that the FFB's grow.

It is accepted within the industry that there is need for a system or apparatus that mechanizes the process of harvesting the oil palm FFB at height to increase harvesting yield.

Commercially available personnel aerial lift devices, including articulated or telescopic boom lifts and scissor lift platforms have been modified and tested in efforts to facilitate the harvesting process at height. The industry has found these devices cannot efficiently position an operator to cut an FFB at any location around the circumference of an oil palm plant at harvesting height, cannot efficiently capture and store the FFBs once cut and cannot travel over the ground fast enough to be economically practical.

It is recognized and accepted within the industry that capturing, cutting and harvesting the FFB at heights from 8 to 15 meters at any location around the circumference of the tree and moving between FFB producing trees within a cycle time that is economical with 1 operator and minimal handling of the FFB to prevent damage is necessary for the long term viable economic health of the industry.

The speed, mobility and mechanical operating limitations of the current technologies available within existing commercial, modified or developed mobile aerial lift devices to date have not offered a solution to the mechanization of the harvesting of palm oil.

It is, therefore, desirable to provide a harvesting apparatus that overcomes the shortcomings of the prior art solutions for harvesting tall growing crops, such as fresh fruit bunches from oil palm trees.

### SUMMARY

An apparatus and method for harvesting tall growing crops is provided.

To address the technological limitations of the prior art, in some embodiments, the apparatus can comprise an integrated self-propelled, semi-automated harvesting apparatus 100 with automated leveling, a ramp type FFB storage dump tray, a semi-automated telescoping aerial lift tower with an automated telescoping structural stabilizer mechanism, a semi-automated 3-link rotatably articulating extendable manipulator arm mechanism with an operator carrying platform or basket, a mechanized FFB capturing screw device and a mechanized FFB cutting device.

In some embodiments, the apparatus can comprise an automated software and logic system allowing control of all machine-mechanical functions by one operator to reduce the harvesting cycle time and manpower requirements.

In some embodiments, the apparatus can facilitate the harvesting of FFBs at height, significantly reduce handling of the FFBs, significantly reduce damage of the FFBs, significantly reduce manpower requirements to harvest the FFBs, significantly reduce labor fatigue to harvest the FFBs, significantly reduce the costs of harvesting FFBs from heights of 8 to 13 meters and significantly increase FFB harvest yield.

Broadly stated, in some embodiments, an apparatus can be provided for harvesting tall growing crops, the apparatus comprising: a vehicle, the vehicle comprising a propulsion mechanism configured to propel the vehicle; an extendable tower disposed on the vehicle, the extendable tower configured to raise and lower between a lower position and a raised position; an operator platform operatively coupled to an upper end of the telescoping tower via an articulated arm mechanism, the extendable tower configured to move the operator platform between the lower position and the raised position; a stabilizing mechanism operatively coupled between the vehicle and the upper end of the extendable tower, the stabilizing mechanism configured to stabilize the extendable tower when in the raised position; a tray for receiving the crops harvested, the tray further comprising a gate configured to open and release the crops harvested; a plurality of outrigger jacks disposed around a perimeter of the vehicle for stabilizing the vehicle in a substantially level configuration when the apparatus is used for harvesting the tall growing crops; and a control system for controlling the operation of one or more of the vehicle, the extendable tower, the stabilizing mechanism, the operator platform, the tray, the gate, and the plurality of outrigger jacks.

Broadly stated, in some embodiments, the stabilizing mechanism can comprise a pair of substantially parallel telescoping support arms disposed between the vehicle and the upper end of the telescoping tower.

Broadly stated, in some embodiments, each of the pair of substantially parallel telescoping support arms can comprise a collar configured to prevent the pair of substantially parallel telescoping support arms from telescoping when the extendable tower has raised the operator platform to the raised position.

Broadly stated, in some embodiments, the apparatus can further comprise a tensioning mechanism for placing tension in the stabilizing mechanism when the operator platform is in the raised position.

Broadly stated, in some embodiments, the propulsion mechanism can comprise an engine operatively coupled to a hydraulic fluid system operatively coupled to a hydraulic fluid vehicle drive mechanism.

Broadly stated, in some embodiments, the hydraulic fluid mechanism can be configured for operating one or more of the extendable tower, the stabilizing mechanism, the tensioning mechanism, the gate, and the plurality of outrigger jacks.

Broadly stated, in some embodiments, the articulated arm mechanism can be configured to move the operator platform away and towards the upper end of the extendable tower.

Broadly stated, in some embodiments, the articulated arm mechanism can move on a substantially horizontal plane.

Broadly stated, in some embodiments, the articulated arm mechanism can comprise a plurality of arm segments pivotally attached together in a sequential configuration, further comprising a pivotal attachment between adjacent arm segments, the pivotal attachment configured to rotate about a substantially vertical axis.

Broadly stated, in some embodiments, a first end of the articulated arm mechanism can be pivotally attached to the upper end of the extendable tower with a pivotal attachment, and wherein a second end of the articulated arm mechanism can be pivotally attached to the operator platform with another of the pivotal attachment, the pivotal attachment configured to rotate about a substantially vertical axis.

Broadly stated, in some embodiments, the pivotal attachment can comprise an electric motor mechanism.

Broadly stated, in some embodiments, the electric motor mechanism the electric motor mechanism can comprise a direct current servo electric motor.

Broadly stated, in some embodiments, the control system can comprise a main controller disposed on the vehicle and a slave controller disposed on the operator platform, each of the main controller and the slave controller can be configured to control the operation of one or more of the vehicle, the extendable tower, the stabilizing mechanism, the operator platform, the tray, the gate, and the plurality of outrigger jacks.

Broadly stated, in some embodiments, the operator platform can comprise one or more of a joystick controller, a steering controller, at least one push button switch, a mode selection switch, at least one visual indicator, and a visual display screen operatively coupled to the slave controller.

Broadly stated, in some embodiments, a method can be provided for harvesting tall growing crops, the method comprising: moving the apparatus near a tree comprising a tall growing crop; moving the operator platform near the tall growing crop to be harvested; harvesting the tall growing crop from the tree; and placing the harvested crop into the tray.

Broadly stated, in some embodiments, the method can further comprise repeating the foregoing steps therein until the tray is full of a plurality of the harvested crop.

Broadly stated, in some embodiments, the method can further comprise emptying the tray.

Broadly stated, in some embodiments, the tall growing crops can comprise fresh fruit bunches from oil palm trees.

### BRIEF DESCRIPTION OF THE DRAWINGS

FIG. 1 is a perspective view depicting one embodiment of an apparatus for harvesting tall growing crops.

FIG. 2 is a side elevation view depicting the apparatus of FIG. 1.

FIG. 3 is a front elevation depicting the apparatus of FIG. 1.

FIG. 4 is a top plan view depicting the apparatus of FIG. 1.

FIG. 5 is a perspective view depicting the apparatus of FIG. 1 next to a palm tree, in a harvesting mode.

FIG. 6 is a front elevation view depicting the apparatus of FIG. 5.

FIG. 7 is a side elevation view depicting the apparatus of FIG. 5.

FIG. 8 is a perspective view depicting the apparatus of FIG. 5 in an extended and cutting position.

FIG. 9 is a perspective view depicting the apparatus of FIG. 5 with FFBs being unloaded into a FFB storage dump tray disposed thereon.

FIG. 10 is a perspective view depicting the apparatus of FIG. 8 adjacent to a palm tree during the harvesting of FFBs thereof.

FIG. 11 is a perspective view depicting the apparatus of FIG. 10, removing a FFB from a palm tree.

FIG. 12 is a top plan view depicting the apparatus of FIG. 10, removing a FFB from a palm tree.

FIG. 13 is a top plan view depicting the apparatus of FIG. 10, with an extendable manipulator arm extended in a clockwise position around a palm tree.

FIG. 14 is a top plan view depicting the apparatus of FIG. 10, with an extendable manipulator arm extended in a counter-clockwise position around a palm tree.

FIG. 15 is a top plan view depicting an operator platform of the apparatus of FIG. 1.

FIG. 16 is a perspective view depicting the apparatus of FIG. 1 unloading FFBs into a storage tray.

FIG. 17 is a block diagram depicting operation of the apparatus of FIG. 1 harvesting FFBs from palm trees.

FIG. 18 is a block diagram depicting one embodiment of a control system for the apparatus of FIG. 1.

FIG. 19 is a hydraulic schematic diagram depicting one embodiment of a hydraulic control system for the apparatus of FIG. 1.

FIG. 20 is a side elevation view depicting one embodiment of an operator platform of the apparatus of FIG. 1.

FIG. 21 is a rear perspective view depicting the operator platform of FIG. 20.

### DETAILED DESCRIPTION OF EMBODIMENTS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment can also be included in other embodiments, but is not necessarily included. Thus, the present technology can include a variety of combinations and/or integrations of the embodiments described herein.

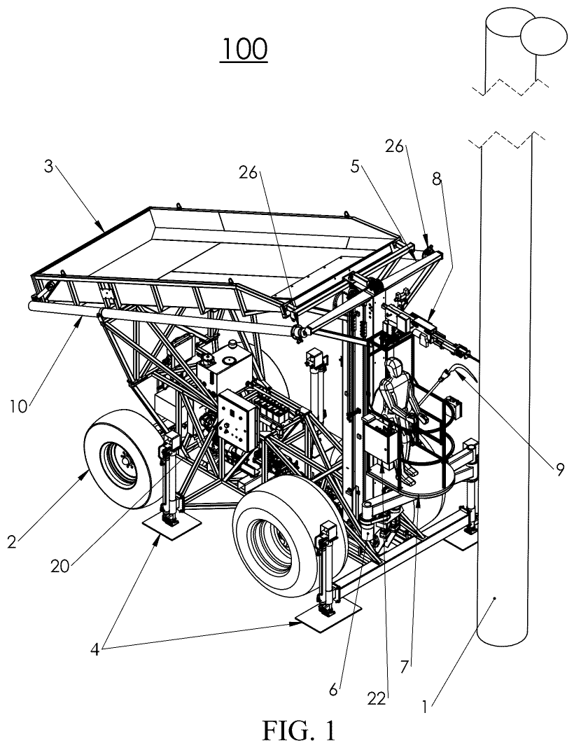

Referring to FIG. 1, a perspective view is shown depicting one embodiment of harvesting apparatus 100 in a traveling mode, approaching an oil palm tree 1 at traveling height. In some embodiments, harvesting apparatus 100 can comprise of self-propelled carrier 2, ramp type FFB storage dump tray 3, carrier chassis leveling outriggers 4 shown in the retracted traveling position, vertically extendable tower 5 shown in the retracted and lowered position at traveling height, telescoping structural stabilizer mechanism 10 shown in the retracted and locked position, semi-automated 3-link rotatably articulating extendable manipulator arm mechanism 6 shown in the collapsed and traveling position, operator carrying platform 7 shown in the traveling position, and FFB capturing screw device 8 and FFB cutting device 9 shown in traveling positions.

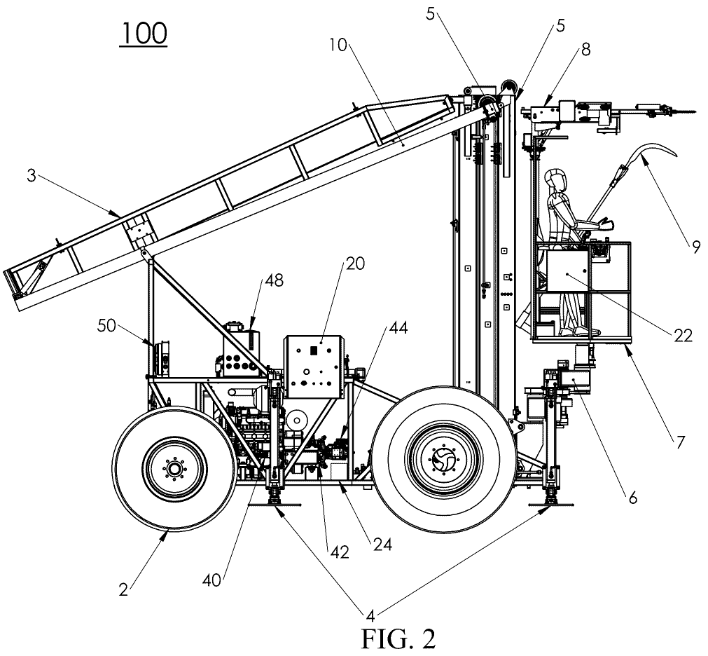

Referring to FIG. 2, a side elevation view of harvesting apparatus 100 is shown in the traveling mode at traveling height showing self-propelled carrier 2, ramp type FFB storage dump tray 3, carrier chassis leveling outriggers 4 in the retracted traveling position, vertically extendable tower 5 in the retracted and lowered position at traveling height, telescoping structural stabilizer mechanism 10 in the retracted and locked position, semi-automated 3-link rotatably articulating extendable manipulator arm mechanism 6 in the collapsed and traveling position, operator platform 7 or basket in the traveling position, and FFB capturing screw device 8 and FFB cutting device 9 in traveling positions.

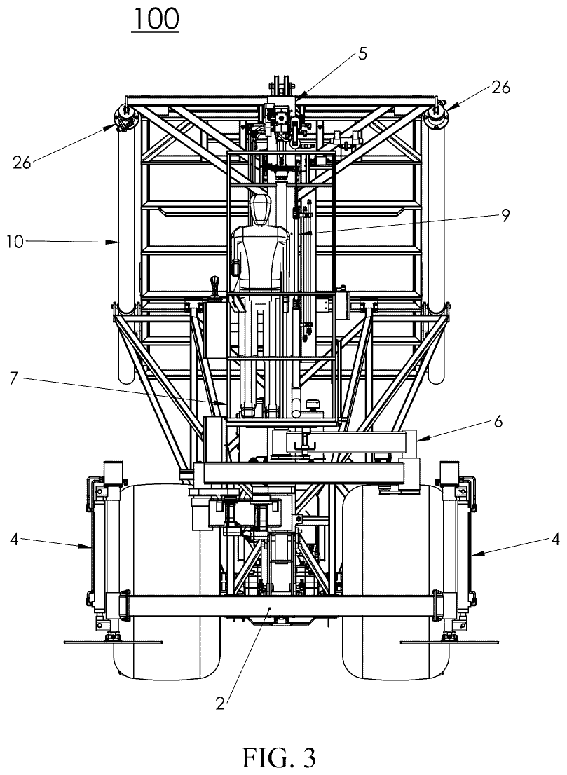

Referring to FIG. 3, a front elevation view of harvesting apparatus 100 is shown in the traveling mode at traveling height showing self-propelled carrier 2, carrier chassis leveling outriggers 4 in the retracted traveling position, vertically extendable tower 5 in the retracted and lowered position at traveling height, telescoping structural stabilizer mechanism 10 in the retracted and locked position, semi-automated 3-link rotatably articulating extendable manipulator arm mechanism 6 in the collapsed and traveling position, operator platform 7 or basket in the traveling position, and FFB cutting device 9 in traveling positions.

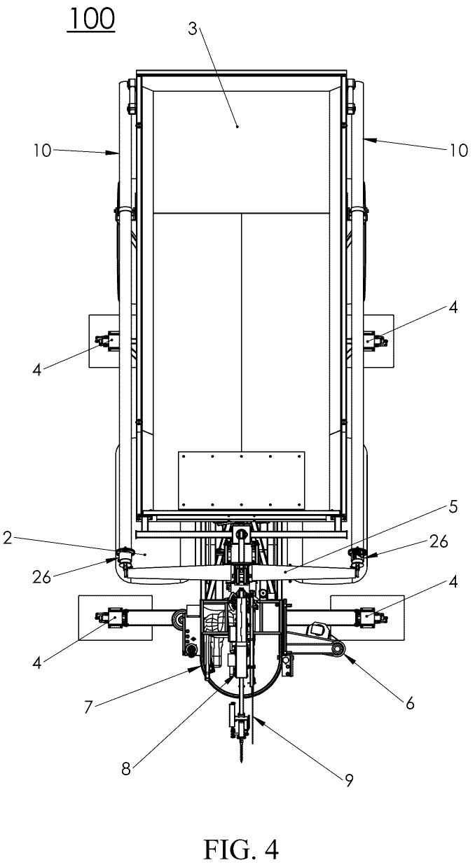

Referring to FIG. 4, a top view of harvesting apparatus 100 is shown in the traveling mode at traveling height showing self-propelled carrier 2, ramp type FFB storage dump tray 3, carrier chassis leveling outriggers 4 in the retracted traveling position, vertically extendable tower 5 in the retracted and lowered position at traveling height, telescoping structural stabilizer mechanism 10 in the retracted and locked position, semi-automated 3-link rotatably articulating extendable manipulator arm mechanism 6 in the collapsed and traveling position, operator platform 7 or basket in the traveling position, and FFB capturing screw device 8 and FFB cutting device 9 in traveling positions.

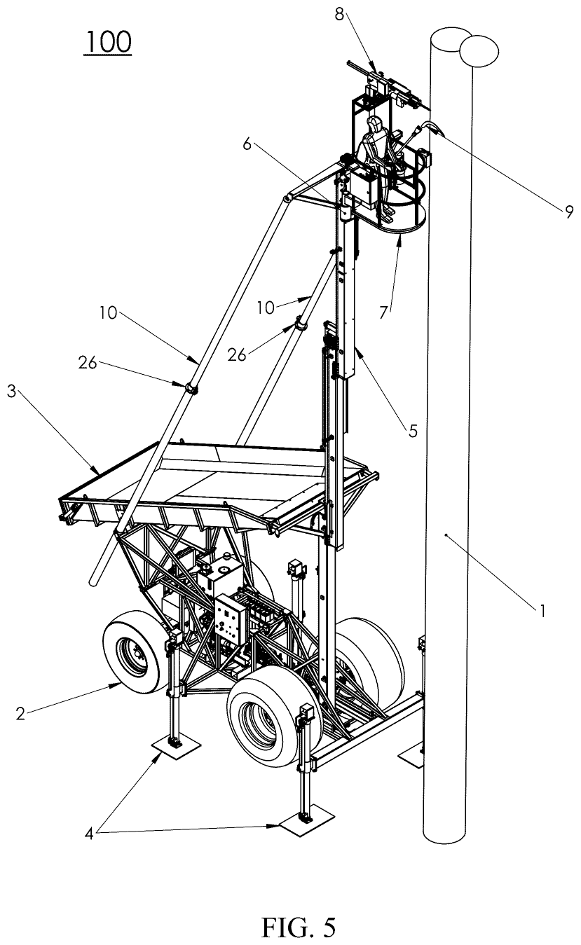

Referring to FIG. 5, a perspective view of harvesting apparatus 100 is shown in the harvesting mode adjacent to palm tree 1 at harvesting position and height showing self-propelled carrier 2, ramp type FFB storage dump tray 3, carrier chassis leveling outriggers 4 in the extended and harvesting position, vertically extendable tower 5 in the extended harvesting position at cutting height in a raised position, telescoping structural stabilizer mechanism 10 in the extended and locked position, semi-automated 3-link rotatably articulating extendable manipulator arm mechanism 6 extended to the cutting position, operator platform 7 positioned in close proximity to the FFB in the cutting position, FFB capturing screw device 8, and FFB cutting device 9.

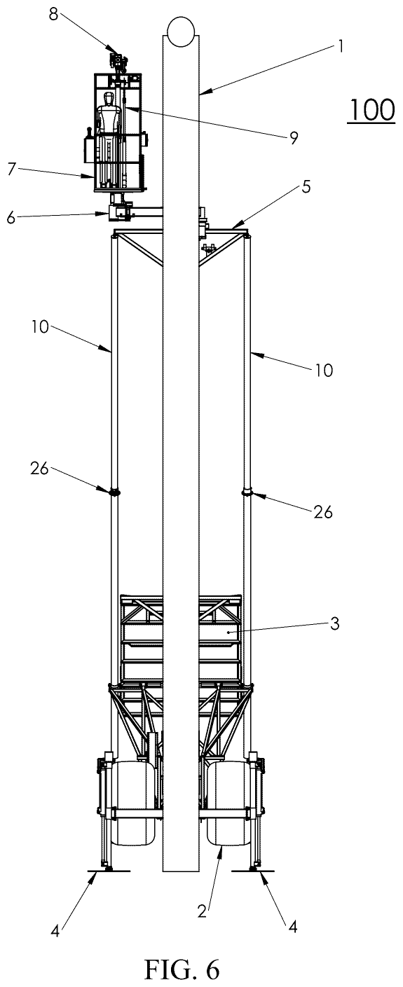

Referring to FIG. 6, a front side elevation view of harvesting apparatus 100 is shown in the harvesting mode adjacent to palm tree 1 at harvesting position and height showing self-propelled carrier 2, ramp type FFB storage dump tray 3, carrier chassis leveling outriggers 4 in the extended and harvesting position, vertically extendable tower 5 in the extended cutting position at cutting height, telescoping structural stabilizer mechanism 10 in the extended and locked position, the telescoping rods of stabilizer mechanism 10 locked by locking collars 26 disposed on each.

Semi-automated 3-link rotatably articulating extendable manipulator arm mechanism 6 is shown extended to the cutting position, operator platform 7 positioned in close proximity to the FFB in the cutting position, FFB capturing screw device 8, and FFB cutting device 9.

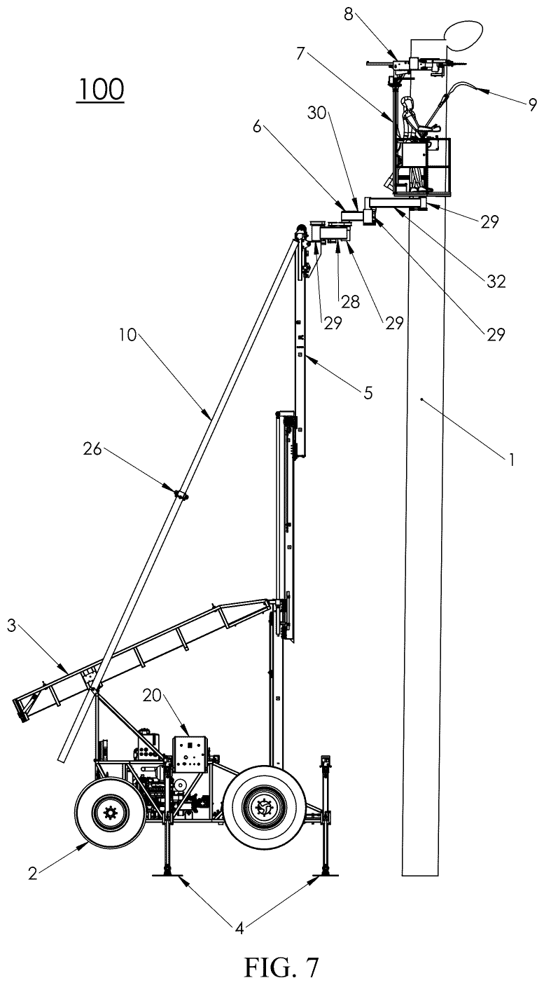

Referring to FIG. 7, a side elevation view of harvesting apparatus 100 is shown in the harvesting mode adjacent to palm tree 1 at harvesting position and height showing self-propelled carrier 2, ramp type FFB storage dump tray 3, carrier chassis leveling outriggers 4 in the extended and harvesting position, vertically extendable tower 5 in the extended cutting position at cutting height, telescoping structural stabilizer mechanism 10 in the extended and locked position, semi-automated 3-link rotatably articulating extendable manipulator arm mechanism 6 extended to the cutting position, operator platform 7 positioned in close proximity to the FFB in the cutting position, FFB capturing screw device 8, and FFB cutting device 9. In some embodiments, arm mechanism 6 can comprise three arm segments 28, 30, 32 pivotally to each other in a sequential configuration via pivotal attachment 29. In some embodiments, a first end of arm mechanism 6 can be pivotally attached to an upper end of extendable tower 5 via pivotal attachment 29, whereas a second end of arm mechanism 6 can be pivotally attached to operator platform 7 via pivotal attachment 29. In some embodiments, pivotal attachment 29 can comprise an electric motor mechanism. In some embodiments, the electric motor mechanism can comprise a direct current servo electric motor as well known to those skilled in the art.

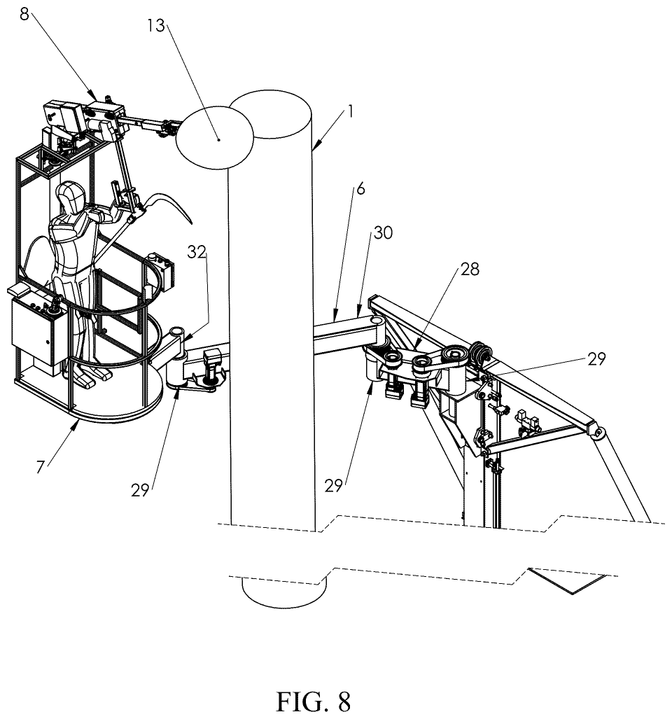

Referring to FIG. 8, a perspective view of harvesting apparatus 100 is shown with operator platform 7 in the extended and cutting position at cutting height, semi-automated 3-link rotatably articulating extendable manipulator arm mechanism 6 extended to the cutting position, and FFB capturing screw device 8 engaging FFB 13.

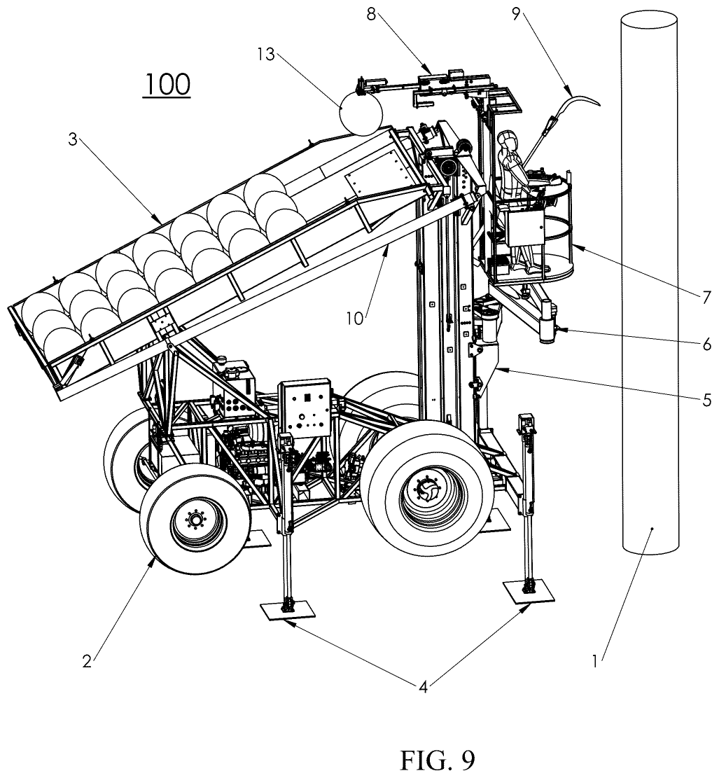

Referring to FIG. 9, a perspective view of harvesting apparatus 100 is shown in the harvesting mode adjacent to palm tree 1 at the FFB unload position and height unloading FFB 13 from FFB capturing screw device 8 into ramp type FFB storage dump tray 3, showing self-propelled carrier 2, FFB ramp tray 3, carrier chassis leveling outriggers 4 in the extended and engaged position, vertically extendable tower 5 in the retracted and lowered position at the unload elevation, telescoping structural stabilizer mechanism 10 in the retracted and locked position, semi-automated 3-link rotatably articulating extendable manipulator arm mechanism 6 retracted, operator platform 7 in the unload position and height, FFB capturing screw device 8 in the unload position above ramp tray 3, and the FFB cutting device 9 in the travel position.

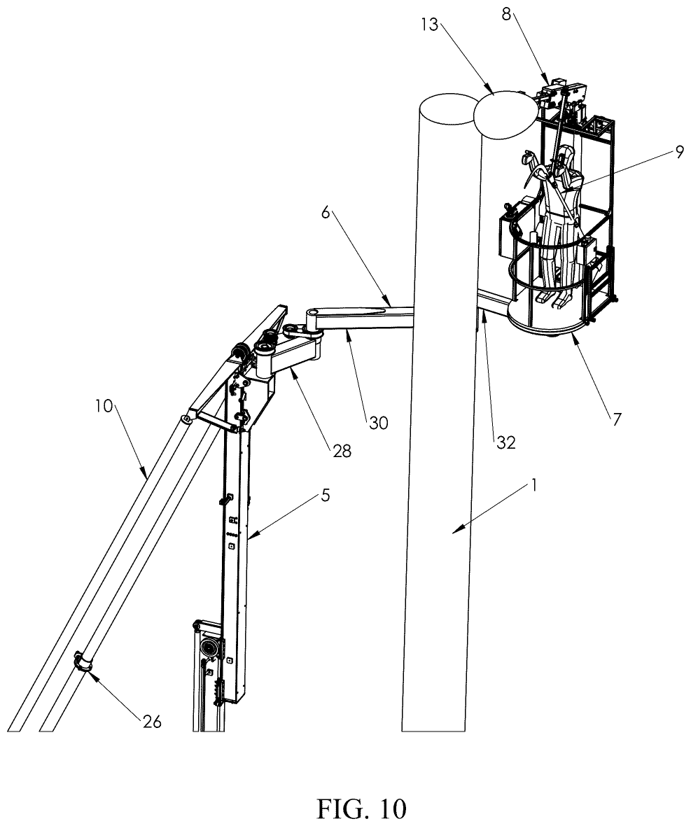

Referring to FIG. 10, a perspective view of harvesting apparatus 100 is shown in the harvesting mode adjacent to palm tree 1 at the cutting elevation showing FFB 13, FFB capturing screw device 8, vertically extendable tower 5 in the extended position at the cutting height, telescoping structural stabilizer mechanism 10, semi-automated 3-link rotatably articulating extendable manipulator arm mechanism 6 extended in the clockwise direction around the palm in the cutting position, operator platform or basket 7 positioned in close proximity to the FFB 13 in cutting position, FFB capturing screw device 8, and FFB cutting device 9.

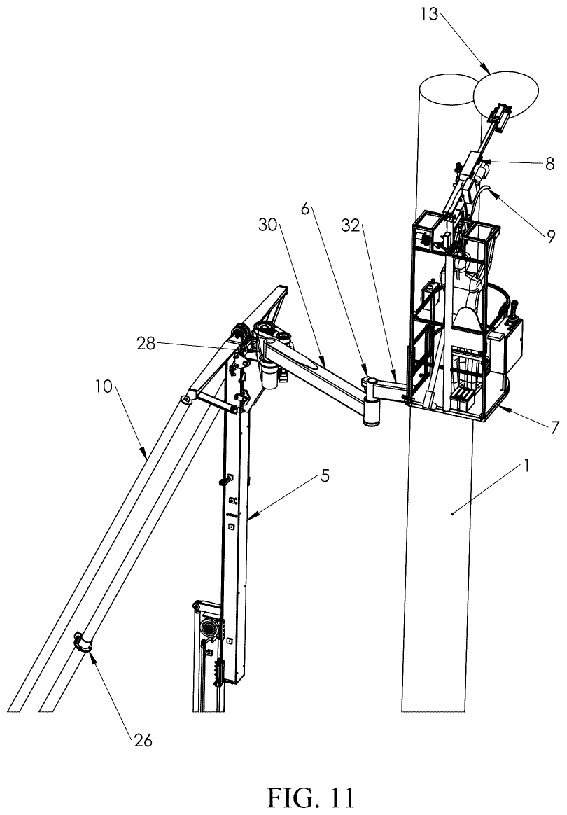

Referring to FIG. 11, a perspective view of harvesting apparatus 100 is shown in the harvesting mode adjacent to palm tree 1 at the cutting height showing FFB 13, FFB capturing screw device 8, vertically extendable tower 5 in the extended position at the cutting height, telescoping structural stabilizer mechanism 10, semi-automated 3-link rotatably articulating extendable manipulator arm mechanism 6 extended in the counter-clockwise direction around the palm in the cutting position, operator platform or basket 7 positioned in close proximity to FFB 13 in cutting position, FFB capturing screw device 8, and FFB cutting device 9.

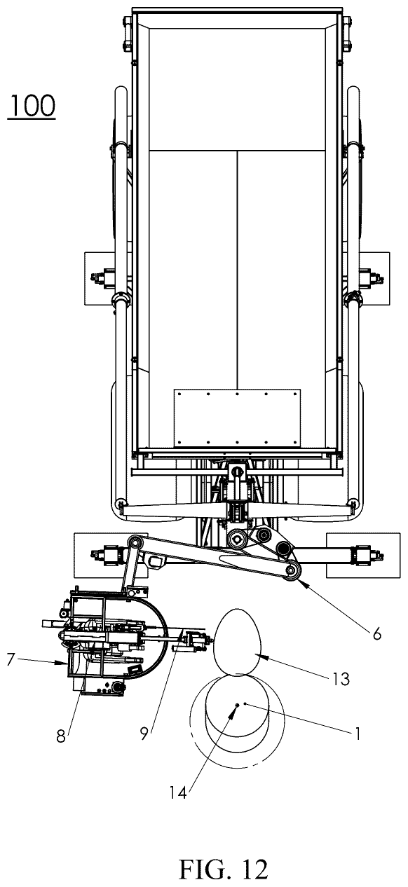

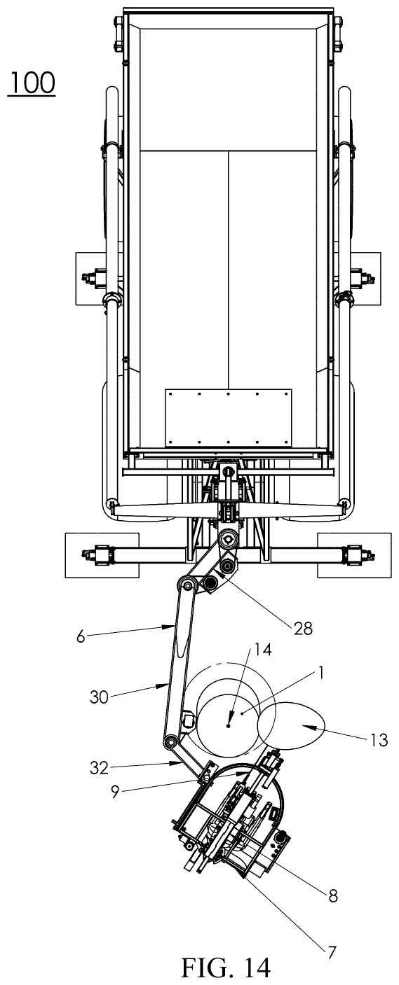

Referring to FIG. 12, a top view of harvesting apparatus 100 is shown in the harvesting mode adjacent to palm tree 1 at the cutting height showing the operator platform 7 positioned in close proximity to FFB 13 in the cutting position, FFB capturing screw device 8 in cutting position, FFB cutting device 9 in cutting position, and semi-automated 3-link rotatably articulating extendable manipulator arm mechanism 6 extended in the counter-clockwise direction around palm tree 1 in the cutting position. Further, FIG. 14 shows the limited radial distance from center 14 of palm tree 1 to deployable rotatably articulating extendable manipulator arm assembly 6 at any harvesting position circumferentially around the palm.

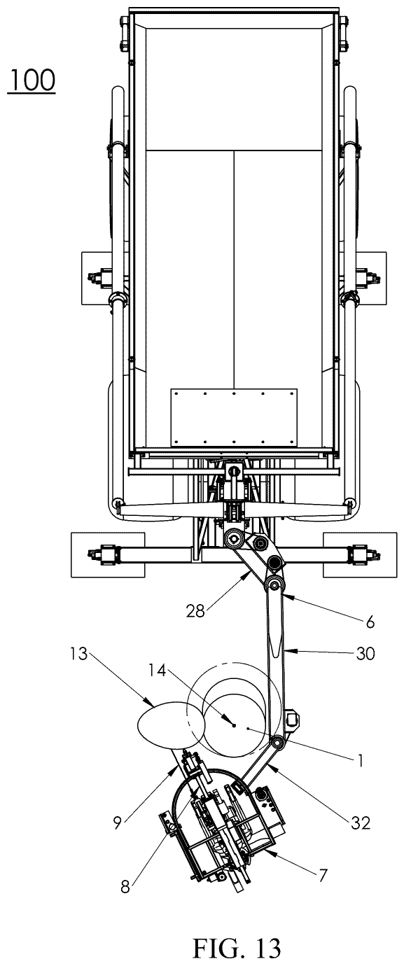

Referring to FIG. 13, a top plan view of harvesting apparatus 100 is shown in the harvesting mode adjacent to palm tree 1 at the cutting elevation showing operator platform 7 positioned in close proximity to FFB 13 in the cutting position, FFB capturing screw device 8 in cutting position, FFB cutting device 9 in cutting position, and semi-automated 3-link rotatably articulating extendable manipulator arm mechanism 6 extended in the clockwise direction around the palm in the cutting position. Further, FIG. 13 shows the limited radial distance from center 14 of palm tree 1 to deployable horizontal boom track 6 at any harvesting position circumferentially around palm tree 1.

Referring to FIG. 14, a top plan view of harvesting apparatus 100 is shown in the harvesting mode adjacent to palm tree 1 at the cutting elevation showing operator platform 7 positioned in close proximity to FFB 13 in the cutting position, FFB capturing screw device 8 in the cutting position, FFB cutting device 9 in the cutting position, and semi-automated 3-link rotatably articulating extendable manipulator arm mechanism 6 extended in the counter-clockwise direction around palm tree 1 in the cutting position. Further, FIG. 14 shows the limited radial distance from center 14 of palm tree 1 to arm mechanism 6 at any harvesting position circumferentially around palm tree 1.

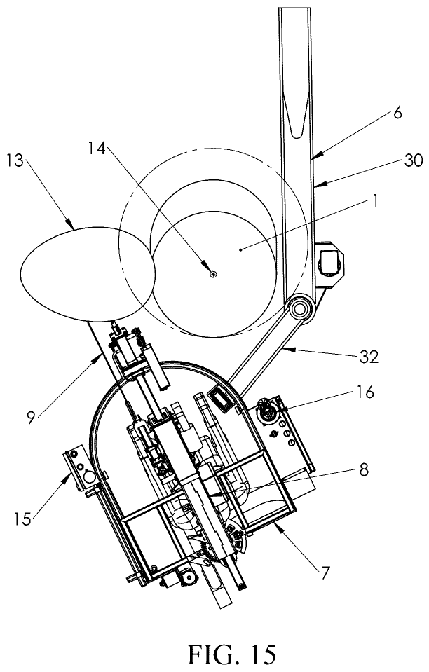

Referring to FIG. 15, a top plan view of harvesting apparatus 100 is shown in the harvesting mode adjacent to palm tree 1 at the cutting elevation showing operator platform positioned 7 in close proximity to FFB 13 in the cutting position, FFB capturing screw device 8 in cutting position, FFB cutting device 9 in cutting position, center 14 of palm tree 1 and semi-automated 3-link rotatably articulating extendable manipulator arm mechanism 6 extended directly at palm tree 1 in the cutting position. Further, FIG. 15 shows operator's control panel 15, and operator's control system joystick 16.

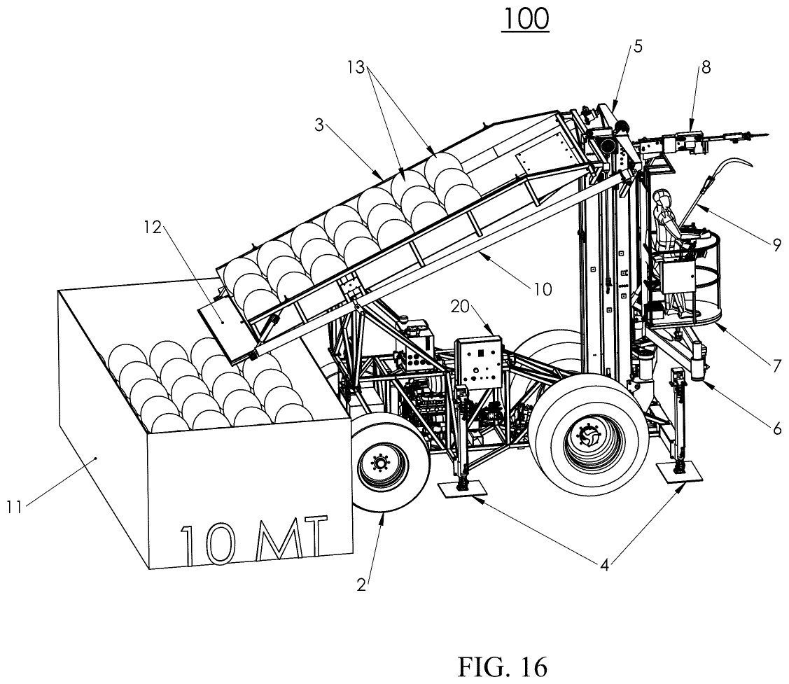

Referring to FIG. 16, a perspective view of harvesting apparatus 100 is shown in the unload mode with self-propelled carrier 2 at low traveling height positioned to unload FFBs 13 with its longitudinal axis point towards and plantation central FFB storage tray 11 showing ramp type FFB storage dump tray 3 with FFB storage dump tray slide gate 12 open, carrier chassis leveling outriggers 4 in the retracted traveling position, vertically extendable tower 5 in the retracted and lowered position at traveling height, telescoping structural stabilizer mechanism 10 in the retracted and locked position, semi-automated 3-link rotatably articulating extendable manipulator arm mechanism 6 in the retracted and traveling position, operator carrying platform or basket 7 in the traveling position, and FFB capturing screw device 8, and FFB cutting device 9 in traveling positions.

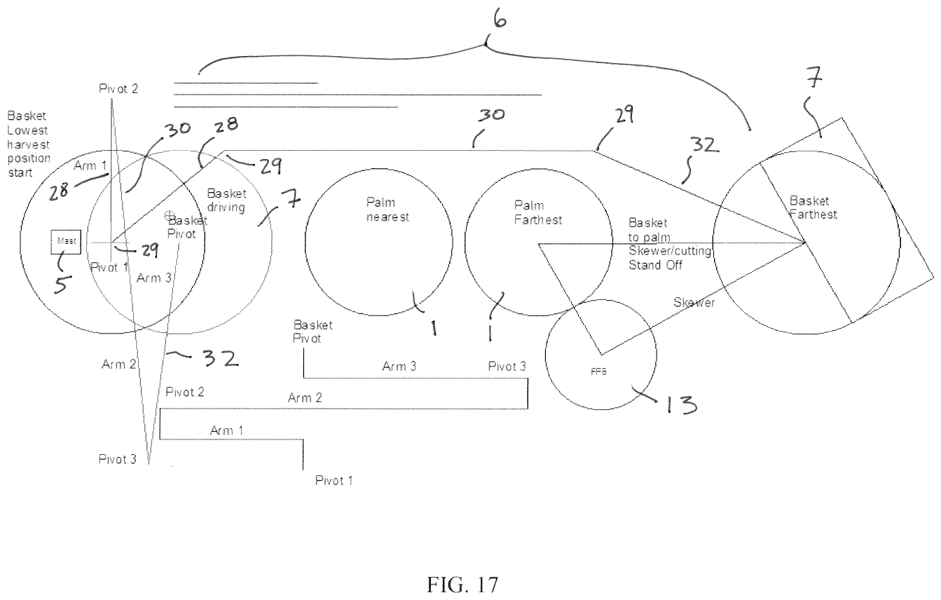

Referring to FIG. 17, a block diagram is provided depicting the functional movements of apparatus 100 about oil palm tree 1, as shown in FIGS. 10 to 15.

### DM1 Palm Harvester Control Scheme

Linkage: For maximum stiffness and ability of arm mechanism 6 to postionally access 360 degrees around oil palm tree 1, arm mechanism can comprise arm segments 28, 30, 32 that can be stacked vertically (can turn on top of each other), and can further comprise unequal lengths such that when arm segments 28, 30, 32 are lined up on top of each other, the pivot attachment of platform 7 (referred to as “Basket” in FIG. 17) is positioned above the pivot attachment disposed on tower 5, allowing the arm segments to rotate underneath platform 7 with no lateral movement of platform 7.

Rotary actuation: In some embodiments, apparatus 100 can comprise a combination of servo motor/drive, Control Area Network (“CAN”) enabled with deep reduction, gearbox, brake and toothed belt/timing chain reduction drive to the pivot shaft.

Pivots: In some embodiments, pivot attachments 29 can comprise a rolling element such as a tapered rolling bearing.

Power and control wiring: In some embodiments, apparatus 100 can comprise a daisy chain of two power wires and 2 CAN wires to one or more of the electrically controlled components disposed thereon.

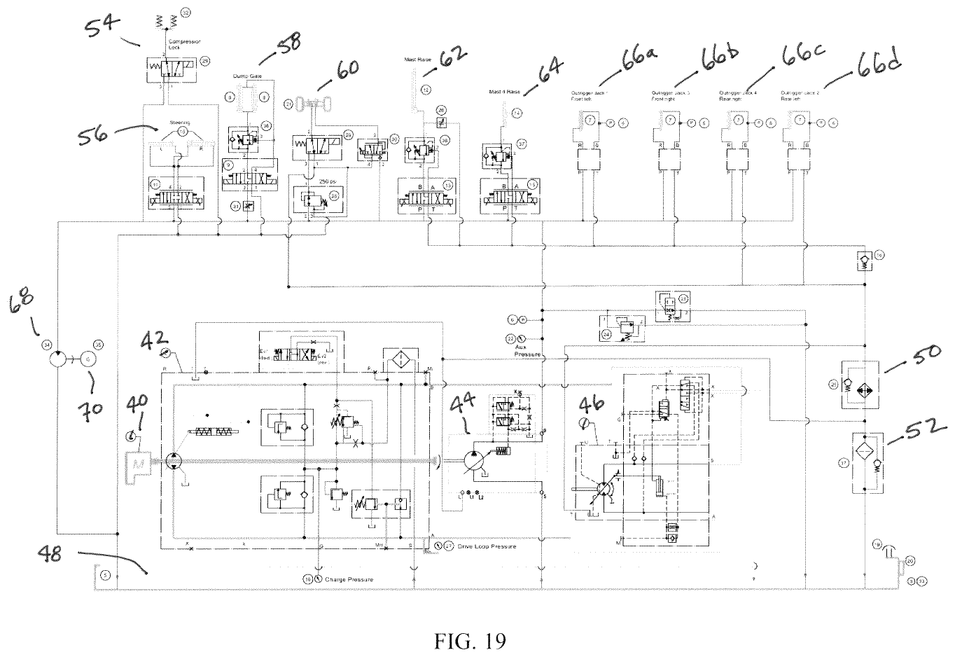

Power: In some embodiments, electrical power for the electrically controlled components can be provided by DC generator 70 as shown in FIG. 19.

### Control Scheme Philosophy

A three-bar linkage following a two-dimension path with an additional constraint to be able to define a unique control path.

In some embodiments, apparatus 100 can comprise two control schemes: Basket Harvest Pre-positioning and Basket Harvest Positioning motion.

Basket Harvest Pre-positioning: once tower 5 has been raised to place platform 7 in a harvesting elevation, arm mechanism 6 can be oriented for clockwise (“CW”) or counterclockwise (“CCW”) movement that is compatible with the palm tree's required CW or CCW FFB harvesting direction. Actuating rocker switch 21, labeled “CW-CCW” (in other embodiments, this can be labelled as “EAST-WEST”), disposed on the top of joystick 16 disposed on operator platform 7 can orient arm segments 28, 30, 32 of arm mechanism 6 for movement in either the CW (east) or CCW (west) direction.

Moving operator platform 7 from the drive position (at elevation) to an initial harvest position on a radius of the palm at a defined distance from the palm can be performed by actuating the joystick “”FORE-AFT” (in other embodiments, this can be labelled as “NORTH-SOUTH”) that can move the basket pivot on a straight line in and out from pivot 1 (to and from the center of the palm) with no change in angularity, and lateral movement CW-CCW on the joystick can cause a change in angularity of that line. Operator platform 7 can be rotated relative to arm mechanism 6 by rotating a rotary controller disposed on operator platform 7 to point the basket in an optimum harvest position relative to the FFB to be harvested.

Basket Harvesting Positioning motion: In some embodiments, operator platform 7 can move around oil palm tree 1 in a circle defined by the center of oil palm tree 1 being defined by an assumed radius of palm and plus the defined distance from palm (2a). Actuating the joystick fore and aft can move operator platform 7 on that radius from center of oil palm tree 1, and lateral CW-CCW movement on the joystick can move operator platform 7 in a circle around oil palm tree 1. The rotary controller can rotate operator platform 7 to point directly at the center of oil palm tree 1 for harvesting.

Constraint of arm 1—all harvesting can start with the basket pivot disposed on top of pivot 1 and the stacked arms rotated to a position best suited for harvesting on either the left (CW) or the right (CCW) side of oil palm tree 1 (the two positions being mirror images). Arm segment 1 can be moved to be behind tower 5 and then can move forward as a function of the basket pivot distance from the mast, ending up at the angle illustrated in FIG. 17, with the basket able to reach the “Basket farthest position”. The motion can be predefined by ensuring that the position of the basket at the end of the positioning movements can be fixed for the harvest operation—i.e., won't let any arm segment run into the palm being harvested and will allow 360 access to the palm.

Return to home (of the basket from the harvesting position): in “motion scheme”, can return operator platform 7 to beginning of motion position and from there to the high drive position.

### Operator Platform Movement Definition

Harvest positioning. Travel of operator platform 7 can be defined by polar coordinates with the pivot attachment 29 disposed on tower 5 being defined as the origin and 0 degrees being the axis of the machine pointing aft. Arm segment 1 can be constrained to a position slightly behind the pivot (positive directions towards the palm) and on the opposite side of the pivot from the side being accessed by the basket. Constrained in this way, operator platform 7 can reach the farthest desired position by manipulating arm segment 1. Programming movement of arm segments 2 and 3 get to the start position which is operator platform pivot, arm segment 1 pivot and the center of the palm in line.

Harvest motion. Operator platform 7 can be maneuvered around a relative set of polar coordinates with the origin being the center of the palm tree. Arm segments 1, 2 and 3 can be rotated in a coordinated motion to optimize a given angular and radius position of operator platform 7 relative to the palm following a circular path around the palm.

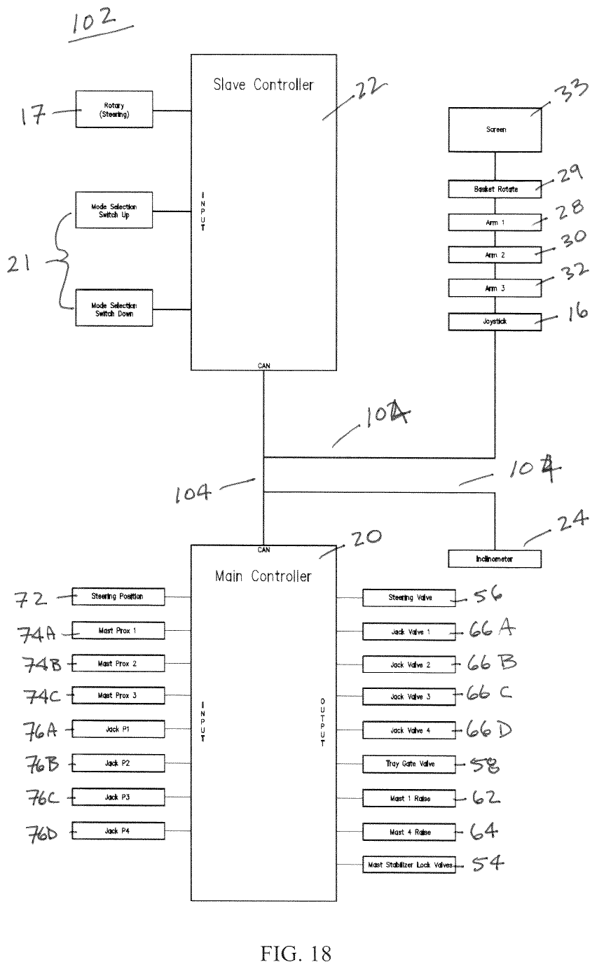

Referring to FIG. 18, a block diagram is shown depicting one embodiment of control system 102 for apparatus 100. In some embodiments, control system 102 can comprise of main controller 20, which be disposed on vehicle 2. Main controller 20 can comprise a programmable logic controller, a microcontroller or other functionally equivalent controller device as well known to those skilled in the art. In some embodiments, control system 102 can further comprise slave controller 22, which can be disposed on operator platform 7. Main controller 20 and slave controller 22 can communicate to each other, and to other components disposed on apparatus 100 as shown in FIG. 18, over network 104 as well known to those skilled in the art. In some embodiments, network 104 can comprise a CAN Bus as well known to those skilled in the art but in other embodiments, other functionally equivalent networks known to those skilled in the art can be used. In some embodiments, slave controller 22 can receive input commands or signals from rotary controller 17 and from joystick 16 and rocker switch 21 over network 104. In some embodiments, main controller 20 can receive input commands or signals from steering position sensor 72 disposed on a steering mechanism of vehicle 2, from tower/mast proximity sensors 74A, 74B, 74C disposed on tower 5, and from sensors 76A, 76B, 76C, 76D disposed on the four outrigger jacks 4. Main controller 20 can also receive input signals from inclinometer 24 disposed on vehicle 2 to provide input to controller 20 so as to level vehicle 2 before initiating modes of harvesting operations.

In some embodiments, either or both of main and slave controllers 20 and 22 can send commands or signals to one or more of display screen 33 disposed on operator platform 7, arm segments 28, 30, 32, pivot attachments 29 as well as to steering valve 56, dump tray gate valve 58, outrigger jack valves 66A, 66B, 66C, 66D, mast 1 raise valve 62, mast 4 raise valve 64 and mast stabilizer lock valves 54.

Referring to FIG. 19, a hydraulic schematic is shown depicting one embodiment of hydraulic system 106 for use with apparatus 100. In some embodiments, hydraulic system 106 can comprise of engine 40 disposed on vehicle 2. Engine 40 can comprise of an internal combustion engine or other functionally equivalent device, such as electric motor drive systems, as well known to those skilled in the art. In some embodiments, engine 40 can operate drive pump 42 that can draw hydraulic fluid from fluid reservoir 48 and then provide pressurized hydraulic fluid to operate hydraulic drive motor 46 to provide motive power to move vehicle 2. In some embodiments, engine 40 can operate auxiliary hydraulic pump 44 to draw hydraulic fluid from reservoir 48 to operate other hydraulic equipment disposed on apparatus 100 as described as follows.

In some embodiments, pump 44 can provide pressurized hydraulic fluid to operate one or more of the following components: steering valve 56, dump tray gate valve 58, vehicle brake mechanism 60, outrigger jack valves 66A, 66B, 66C, 66D, mast 1 raise valve 62, mast 4 raise valve 64 and mast stabilizer lock valves 54. In some embodiments, pump 44 can provide pressurized hydraulic fluid to operate hydraulic motor 68 that can operate direct current (“DC”) electric generator 70 that can provide DC electric power to electrically powered components disposed on apparatus 100. Hydraulic system 106 can also comprise hydraulic fluid cooler 50 and filter 52 as well known to those skilled in the art for cooling and filtering hydraulic fluid used by hydraulic system 106 before being returned to reservoir 48.

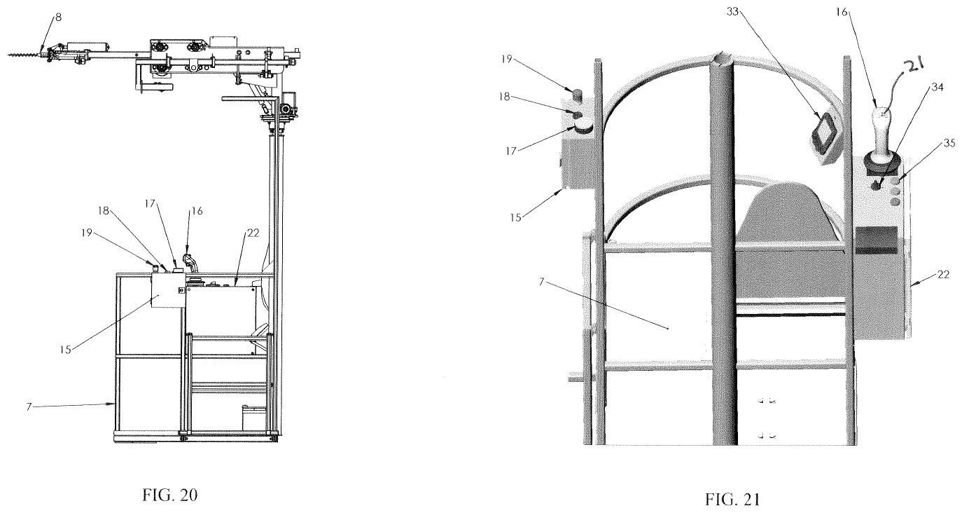

Referring to FIGS. 20 and 21, one embodiment of operator platform 7 is shown. In some embodiments, operator platform can comprise the following:

Operator Controls:
Joystick 16
   2 Axis, spring centered, proportional
   3-position spring centered rocker switch 21 integrated on top of joystick handle
   can be controlled by operator's right hand
   Joystick handle movements: axis #1: Fore-Aft, and axis #2: CW-CCW
   The operational function of the joystick changes depending on which of 5 operating modes the operator selects with the Operating Mode Selector Switches 34.
   Rocker switch 21 CW-CCW movement moves the 3 bar linkage arms in the Basket Harvest Pre-position mode of operation to orient the arms for CW or CCW movement of the basket when in the Basket Harvesting Positioning mode
Rotary Controller 17
   CW & CCW rotary control, spring centered
   can be controlled by operator's left hand
   the operational function of rotary controller 17 can change depending on which of 5 operating modes the operator selects with the Operating Mode Selector Switches 34
Operating Mode Selector Switches 34
   in some embodiments, can comprise 2 switches, spring return, one incrementally counting up, one incrementally counting down
   in some embodiments, there can be 5 Selector Modes (1-5) determined by the Operating Mode Selector Switches 34 and displayed on the operator's panel screen 33 are:
      Low Drive
      Harvesting Setup & Mast Raise
      Basket Harvest Pre-positioning
      Basket Harvest Positioning
      Home & High Drive
Activation Push Button Control Switch 18
   spring return
   In some embodiments, the operational function of the Activation Push Button Control Switch can change depending on which of 5 operating modes (1-5) the operator selects with the Operating Mode Selector Switches

Description of Operation:
In some embodiments, the desired operating mode can be selected with Operating Mode Selector Switches 34, as set out below:
   Low Drive
   Harvesting Setup & Mast Raise
   Basket Harvest Pre-positioning
   Basket Harvest Positioning
   Home & High Drive
By pushing Activation Button 18 and hold until the operating mode selected is shown on the operator's panel screen

The Operating Modes are discussed in more detail below:
Low Drive Mode
   Select the Low Drive operating mode (1) with the Operating Mode Selector Switches 34
   Push the Activation Button 18 and hold until confirmation of the Low Drive operating mode is shown on the operator's panel screen (1)
      This is the lowest drive position of operator platform 7 when driving apparatus 100 to discharge the FFB tray into the central collection tray or to reposition the harvester between field locations
      In this operating mode, the Joystick Fore-Aft axis can control the speed of apparatus 100
      In this operating mode, the amount of rotation from the (spring) centered position of rotary controller 17 can be proportional to the turning radius of apparatus 100
Harvesting Setup & Mast Raise Mode
   Select the Harvesting Setup & Mast Raise operating mode (2) with the Operating Mode Selector Switches 34
   Push and hold the Activation Button 18 until confirmation of the Harvesting Setup & Mast Raise operating mode selected is shown on the operator's panel screen (2), and to signal the harvester control system to automatically extend the leveling downriggers (jacks) to level the harvester
   Release the Activation Button thereby directing the controls to the mast raise function
      In this operating mode, the Joystick Fore-Aft axis can control the direction (up and down) and the speed of the mast raise operation. The amount of deflection of the joystick determines the speed of the mast raise to the desired basket harvesting elevation
Basket Harvest Pre-Positioning Mode
   Select the Basket Harvest Pre-positioning operating mode (3) with the Operating Mode Selector Switches 34
   Push and hold the Activation Button 18 until confirmation of the Basket Harvest Pre-positioning operating mode selected is shown on the operator's panel screen 33
   The orientation of the 3 bar linkage arms (indicated on the operator's panel screen) is to be compatible with the palm's required FFB harvesting direction (CW or CCW orientation) as a first step in the Basket Harvest Pre-positioning Mode. Actuation of rocker switch 21 (on top of the joystick handle) in CW-CCW movements re-orients the 3-bar linkage arms positioning for either a CW (east) or CCW (west) direction of movement to the FFB harvesting position. The CW or CCW pre-positioning orientation will be indicated on the operator panel screen 33
      This mode can allow operator platform 7 to be moved towards the palm to a known location relative to the palm pre-positioning the basket prior to moving the basket CW or CCW around the palm to the FFB harvesting position
      In this operating mode, the Joystick Fore-Aft axis can control the movement of operator platform in and out on the radius line towards the palm to a predetermined distance from the palm, thus setting the radius of the rotation of the operator's basket around the palm
Basket Harvest Positioning Mode
   Select the Basket Harvest Positioning operating mode (4) with the Operating Mode Selector Switches 34
   Push and hold the Activation Button 18 until confirmation of the Basket Harvest Positioning operating mode (4) selected is shown on the operator's panel screen 33
      This mode allows operator platform 7 to be maneuvered in a CW or CCW circular path around the palm relative to the palm to a desired location to harvest the FFB
      In this operating mode, the Joystick Fore-Aft axis can control the movement of operator platform 7 towards or away from the palm on a radius from the pivot of the basket to the center of the palm
      In this operating mode, the Joystick CW-CCW axis can control the movement of operator platform 7 in a circle around the palm centered on the center of the palm
      In this operating mode, rotary controller 17 can rotate operator platform 7 about its pivot point to optimally maneuver the harvester and grabber to a harvest position
Home & High Drive Mode
   This mode follows the harvesting of FFBs
   Select the Home & High Drive operating mode (5) with the Operating Mode Selector Switches 34
   Push and hold the Activation Button 18 until confirmation of the Home & High Drive operating mode (5) selected is shown on the operator's panel screen 33, and to signal the control's algorithm to direct the return of operator platform 7 to the home position by rotating grabber 8, holding the harvested FFB to a position over the tray, to lower the mast to the high drive position, to activate grabber 8 to drop the FFB into the tray, to return grabber 8 to the home harvesting position over operator platform 7 and to retract the harvester's leveling outriggers to the drive position.
   Release the Activation Button 18 thereby directing the controls to the drive functions
      Highest drive position for moving between palm trees to harvest
      In this operating mode, the Joystick Fore-Aft axis can control the speed of the harvester
      In this operating mode, the amount of rotation of the (spring) centered position of rotary controller 17 can be proportional to the turning radius of the harvester
Once apparatus 100 is driven the next palm to be harvested, the operating cycle can be repeated until the storage tray is full.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the embodiments described herein.

Embodiments implemented in computer software can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, etc.

The actual software code or specialized control hardware used to implement these systems and methods is not limiting of the embodiments described herein. Thus, the operation and behavior of the systems and methods were described without reference to the specific software code being understood that software and control hardware can be designed to implement the systems and methods based on the description herein.

When implemented in software, the functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate transfer of a computer program from one place to another. A non-transitory processor-readable storage media can be any available media that can be accessed by a computer. By way of example, and not limitation, such non-transitory processor-readable media can comprise RAM, ROM, EEPROM, CD-ROM or other optical disk storage, magnetic disk storage or other magnetic storage devices, or any other tangible storage medium that can be used to store desired program code in the form of instructions or data structures and that can be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and/or instructions on a non-transitory processor-readable medium and/or computer-readable medium, which can be incorporated into a computer program product.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

What is claimed is:

1. An apparatus for use in harvesting tall growing crops, the apparatus comprising:
a) a vehicle, the vehicle comprising a propulsion mechanism configured to propel the vehicle;
b) an extendable tower disposed on the vehicle, the extendable tower configured to raise and lower between a lower position and a raised position;
c) an operator platform operatively coupled to an upper end of the telescoping tower via an articulated arm mechanism, the extendable tower configured to move the operator platform between the lower position and the raised position;
d) a stabilizing mechanism operatively coupled between the vehicle and the upper end of the extendable tower, the stabilizing mechanism configured to stabilize the extendable tower when in the raised position;
e) a tray for receiving the crops harvested, the tray further comprising a gate configured to open and release the crops harvested;
f) a plurality of outrigger jacks disposed around a perimeter of the vehicle for stabilizing the vehicle in a substantially level configuration when the apparatus is used for harvesting the tall growing crops; and
g) a control system for controlling the operation of one or more of the vehicle, the extendable tower, the stabilizing mechanism, the operator platform, the tray, the gate, and the plurality of outrigger jacks.

2. The apparatus as set forth in claim 1, wherein the stabilizing mechanism comprises a pair of substantially parallel telescoping support arms disposed between the vehicle and the upper end of the telescoping tower.

3. The apparatus as set forth in claim 2, wherein each of the pair of substantially parallel telescoping support arms comprises a collar configured to prevent the pair of substantially parallel telescoping support arms from telescoping when the extendable tower has raised the operator platform to the raised position.

4. The apparatus as set forth in claim 3, further comprising a tensioning mechanism for placing tension in the stabilizing mechanism when the operator platform is in the raised position.

5. The apparatus as set forth in claim 1, wherein the propulsion mechanism comprises an engine operatively coupled to a hydraulic fluid system operatively coupled to a hydraulic fluid vehicle drive mechanism.

6. The apparatus as set forth in claim 5, wherein the hydraulic fluid mechanism is configured for operating one or more of the extendable tower, the stabilizing mechanism, the tensioning mechanism, the gate, and the plurality of outrigger jacks.

7. The apparatus as set forth in claim 1, wherein the articulated arm mechanism is configured to move the operator platform away and towards the upper end of the extendable tower.

8. The apparatus as set forth in claim 7, wherein the articulated arm mechanism comprises a plurality of arm segments pivotally attached together in a sequential configuration, further comprising a pivotal attachment between adjacent arm segments, the pivotal attachment configured to rotate about a substantially vertical axis.

9. The apparatus as set forth in claim 7, wherein the articulated arm mechanism moves on a substantially horizontal plane.

10. The apparatus as set forth in claim 7, wherein a first end of the articulated arm mechanism is pivotally attached to the upper end of the extendable tower with a pivotal attachment, and wherein a second end of the articulated arm mechanism is pivotally attached to the operator platform with another of the pivotal attachment, the pivotal attachment configured to rotate about a substantially vertical axis.

11. The apparatus as set forth in claim 10, wherein the pivotal attachment comprises an electric motor mechanism.

12. The apparatus as set forth in claim 11, wherein the electric motor mechanism comprises a direct current servo electric motor.

13. The apparatus as set forth in claim 1, wherein the control system comprises a main controller disposed on the vehicle and a slave controller disposed on the operator platform, each of the main controller and the slave controller configured to control the operation of one or more of the vehicle, the extendable tower, the stabilizing mechanism, the operator platform, the tray, the gate, and the plurality of outrigger jacks.

14. The apparatus as set forth in claim 13, wherein the operator platform comprises one or more of a joystick controller, a steering controller, at least one push button switch, a mode selection switch, at least one visual indicator, and a visual display screen operatively coupled to the slave controller.

15. The apparatus as set forth in claim 1, wherein the tall growing crops comprises fresh fruit bunches from oil palm trees.

16. A method for harvesting tall growing crops, the method comprising:
a) moving an apparatus near a tree comprising a tall growing crop, the apparatus comprising:
i) a vehicle, the vehicle comprising a propulsion mechanism configured to propel the vehicle,
ii) an extendable tower disposed on the vehicle, the extendable tower configured to raise and lower between a lower position and a raised position,
iii) an operator platform operatively coupled to an upper end of the telescoping tower via an articulated arm mechanism, the extendable tower configured to move the operator platform between the lower position and the raised position,
iv) a stabilizing mechanism operatively coupled between the vehicle and the upper end of the extendable tower, the stabilizing mechanism configured to stabilize the extendable tower when in the raised position,
v) a tray for receiving the crops harvested, the tray further comprising a gate configured to open and release the crops harvested,
vi) a plurality of outrigger jacks disposed around a perimeter of the vehicle for stabilizing the vehicle in a substantially level configuration when the apparatus is used for harvesting the tall growing crops, and
vii) a control system for controlling the operation of one or more of the vehicle, the extendable tower, the stabilizing mechanism, the operator platform, the tray, the gate, and the plurality of outrigger jacks;
b) moving the operator platform near the tall growing crop to be harvested;
c) harvesting the tall growing crop from the tree; and
d) placing the harvested crop into the tray.

17. The method as set forth in claim 16, further comprising repeating the steps therein until the tray is full of a plurality of the harvested crop.

18. The method as set forth in claim 17, further comprising emptying the tray.

19. The method as set forth in claim 16, wherein the tall growing crops comprises fresh fruit bunches from oil palm trees.
